(19) United States
(12) Patent Application Publication
(10) Pub. No.: US 2014/0267244 A1
(43) Pub. Date: Sep. 18, 2014

(54) INTEGRATED AIPP MAP LAYER

(71) Applicant: Jeffrey Russell Ambroziak, Guilford, CT (US)

(72) Inventor: Jeffrey Russell Ambroziak, Guilford, CT (US)

(21) Appl. No.: 14/215,972

(22) Filed: Mar. 17, 2014

Related U.S. Application Data
(60) Provisional application No. 61/789,344, filed on Mar. 15, 2013.

(51) Int. Cl. G06T 15/00

(52) U.S. Cl. CPC G06T 15/00
USPC 345/419

(57) ABSTRACT

A method includes receiving a request for tiled map data comprising a request for at least one 3D tile, retrieving, in response to the request, at least one retrieved 3D tile and transmitting the retrieved at least one 3D tile.

### CROSS-REFERENCE TO RELATED APPLICATIONS

This application claims the benefit of U.S. provisional patent application Ser. No. 61/789,344 filed Mar. 15, 2013, which is hereby incorporated by reference in its entirety.

### BACKGROUND

1. Field of the Invention

The present invention relates to methods and systems for integrating AIPP maps with two dimensional map renderings.

2. Description of the Related Art

The Ambroziak Infinite Perspective Projection (AIPP), described in U.S. Pat. No. 6,489,962 to Ambroziak et al. and incorporated by reference herein, permits one to create a 3D map of any length and width while allowing the viewer to move both longitudinally and latitudinally about the map as well as moving closer and further away. The AIPP accomplishes this in accordance with exemplary embodiments via the creation of an anaglyphic image comprised of two juxtaposed images, each such image rendered in an orthogonal hue (e.g., blue/red, cyan/red, etc.), wherein each pixel of each of the images is projected from directly above with a uniform eye separation and from a uniform height.

It is further known in the art to provide access to map data via the internet such as via Google Maps. Google Maps, and similar commercial and open source products, operate by mapping large portions of the earth based on a tile system. Specifically, the globe is partitioned into a plurality of 2D tiles that interlock like the squares on a chess board. In most instances, each 2D tile is a binary number of pixels in width. Each 2D tile represents a defined portion of the earth or other planet at a particular scale. Each 2D tile is further stored in a hierarchical tree fashion where in each tile is further subdivided into four tiles having the same pixel dimensions of the parent tile but at twice the resolution. In this fashion, the earth is mapped at various scales in a tiled format that allows one to quickly traverse a tile hierarchy to access mapping data at different scales as one zooms in and out.

The projection used by Google Maps and the like for their tiled map data is such that rows of tile data correspond to lines of equal latitude and columns of tile data correspond to lines of equal longitude. As a result, tiles may be retrieved from a server and displayed on a computer screen including, but not limited to, an iPad, a personal computer, a mobile phone, etc., quite quickly. This results from the fact that the tiled data does not require any further projection and previously retrieved data may be seamlessly combined with newly retrieved data in checkerboard fashion. Also, this process requires little computation on the server side. The server need only traverse the tile tree to find the desired 2D tiles, retrieve them and send them to the requesting client. If one wished to create a 3D anaglyph of the tiled map data by using digital elevation model (DEM) data using traditional (i.e., non-AIPP) methods, each representation of the map data as might result from panning, zooming or moving would require an entirely new projection of the data centered on the middle of the image. This new projection would (1) be computationally intensive and (2) would require access to large volumes of DEM data. Map tile data servers lack the computational power to reproject the data on the fly and pushing the computations to the client side requires sending large volumes of DEM data and likely exceeding the computational power of the client to produce new 3D projections in near real time.

What is therefore needed is a method whereby global map tile data may be displayed in a 3D format but which does not require prohibitive computing power and would not require the transfer of large volumes of data, such as DEM data, between a server and a client displaying the map tile data.

### SUMMARY OF THE INVENTION

In accordance with an exemplary and non-limiting embodiment, A method comprises receiving a request for tiled map data comprising a request for at least one 3D tile, retrieving, in response to the request, at least one retrieved 3D tile and transmitting the retrieved at least one 3D tile.

### BRIEF DESCRIPTION OF THE DRAWINGS

The advantages of the embodiments described above, together with further advantages, may be better understood by referring to the following description taken in conjunction with the accompanying drawings. In the drawings, like reference characters generally refer to the same parts throughout the different views. Also, the drawings are not necessarily to scale, the emphasis instead is placed on conveying the concepts of the embodiments.

FIG. 1 is a block diagram illustrating one embodiment of the system according to an exemplary and non-limiting embodiment.

FIG. 2 is a flow diagram of an exemplary and non-limiting embodiment.

### DETAILED DESCRIPTION

In accordance with an exemplary and non-limiting embodiment, the AIPP is utilized to create and statically store tile data in 3D so as to overcome the myriad problems existing in the art as described above. Using the AIPP, one may map the planet, or a large portion thereof, in a manner corresponding to the tile structure of, for example, Google maps. These 3D tiles may be retrieved, such as from a server in a manner similar to the way map tile data is retrieved, and inserted as another viewing layer in, for example, Google Maps using published APIs. In this manner, a user may toggle back and forth between 2D tiles and 3D tiles while seamlessly switching between Google servers and, perhaps, a third party server on which the AIPP 3D tiles are stored as described more fully below. As used herein, a “3D tile” refers to a single tile of a data set comprising a plurality of tiles which together map a portion of a planet wherein the tile is projected in an infinite perspective projection, such as the AIPP. It is noted that an infinite perspective projection is a projection that makes use of more than one projection point. It is further noted that a 2D tile “corresponds” to a 3D tile. and vice-versa, if the areas represented by each tile at least partially overlap.

With reference to FIG. 1, there is illustrated a system for practicing the various exemplary embodiments described herein. A client device 100 on which a user wishes view the AIPP tiles is in communication, via network 102, with a server 104. Client device 100 is broadly drawn to encompass any and all electronic devices capable of requesting and receiving electronic communications and data via any wired or wireless communication protocol. Examples of client device 100 include, but are not limited to, personal computers, tablets, cellular phones and the like. Client device 100 comprises (1) at least one processor for executing instructions stored on a storage memory, such as internal memory, (2) memory for storing and from which may be accessed stored data, (3) a communications element adapted to enable the transmission and reception of data, (4) a display for displaying data and (5) a user interface via which a user may input information into client device 100. Network 102 may be any network capable of receiving, routing and transmitting electronic communication between devices and/or destinations including, but not limited to, the world wide web, the internet and the like. Server 104 may be any computation device capable of receiving requests, via network 102, from client 100 and transmitting requested data to client 100. In various embodiments described below, server 104 may either store or have access to stored data comprising one or more 2D map tiles and/or one or more 3D tiles.

With reference to FIG. 2, there is illustrated an exemplary and non-limiting embodiment. At step 200, a request is received for at least one 3D tile. The request may additionally comprise a request for one or more 2D tiles corresponding to/covering approximately the same area as the requested one or more 3D tiles. The request may be received at server 104 or may be received at client 100 in the instance that the 2D and/or the 3D tile information is stored locally on the client 100. At step 202, the requested 2D and/or 3D tile data is retrieved. At step 204, the requested tile data is received at client 100 and displayed. In one embodiment, the 3D tile data is displayed as an overlay to the 2D tile data. In such an embodiment, the 3D tile data may be requested from and received from a server 104 or client 100 separate from the device on which is stored and from which is retrieved the 2D tile data. For example, client 100 may access Google Maps over the internet and, prior to displaying the 2D tile data comprising a displayed web page, may overlay 3D tile data for display such as by utilizing one or more published APIs. Such 3D tile data may be received from a third party server or from storage and/or associated with client 100.

In some instances, a problem may arise when one considers the constraints of an image plane when statically storing AIPP tiles covering the entire planet or a large portion of the planet. The image plane of an AIPP map is the elevation of the map that corresponds to the surface of the viewing apparatus (e.g., a monitor, an iPad screen, the paper on which a map is printed, etc.). For example, if the image plane is set at 0 ft. elevation and a map is made of the area surrounding San Francisco, the water in the bay and ocean, being at sea level, or, 0 ft. elevation, will appear to reside flat on the screen. As one pans up into the hills, the hills will appear to rise out of the screen when viewed in 3D. On an iPad, for example, the displayed AIPP tiles may be created at different vertical exaggeration factors such that, no matter how far in one zooms, nothing on the screen rises too far out of the screen e.g., no more than 2 inches, no more than 3 inches, etc. However, each AIPP tile layer corresponding to a given level of magnification has an attendant image plane value. If, for example, one chooses 0 ft. elevation for the image as described above, as one pans east to the Rocky mountains, the 3D image protrudes further and further above the screen. While a hill of San Francisco may appear one inch above the screen using an image plane at sea level, a mountain top further east may appear to be 20 ft in front of the screen when using the same image plane. Such an extreme 3D effect may render the map image unviewable.

In accordance with exemplary and non-limiting embodiments, this problem is solved by utilizing the principle that, in AIPP maps, moving the viewing plane up and down may be achieved by a linear, horizontal translation of the two orthogonal images comprising the AIPP image/map with respect to each other. The amount of movement up or down of the image plane resulting from a linear translation of a single pixel may be computed and stored as associated with each AIPP tile or all the tiles collectively. Maximum and minimum elevations (or other DEM metrics) corresponding to each tile may also be stored for retrieval.

In practice, altering the image plane may occur as follows. A user requests a number of tiles to view in 3D. For example, a user requests AIPP tiles centered in a mountainous region having an average height of 2000 meters. Within the tiles, the maximum deviation of elevation is 50 meters. When the tiles are retrieved, the image info plane info retrieved. For example, the image plane info may indicate that each linear displacement of 1 pixel corresponds to a change in the image plane of 100 meters. Therefore, shifting each orthogonal image in opposite directions twenty pixels will move the image plane to 2000 meters such that the highest hills will not rise very far above the image plane. The server may then retrieve the requested tiles plus the tiles on either side sufficient to provide the additional twenty pixels that will be required when the images are shifted. The server may retrieve the tiles, shift the images, recombine the shifted images and then send the resulting image to the client. In another embodiment, the client device may perform the shift as this requires relatively little processing power. In one embodiment, the client device may be provided a slider, as on a GUI, for moving the image plane up and down within predetermined bounds.

In another embodiment, instead of sending an AIPP tile or tiles formed of image data comprising an AIPP map, there may stored and sent to a user upon request an AIPP translation tile or tiles. An AIPP translation tile is an array corresponding to a tile that details how image pixels of a 2D image are to be distorted to create each of the two orthogonal images comprising an AIPP map. For example, an AIPP translation tile may detail, on a row by row basis, how pixels from a corresponding 2D image are to be stretched and compressed. Because of the small size of each AIPP tile, each AIPP translation tile may use portions of each byte comprising, for example, an integer, to contain this information. Once calculated and statically stored, an AIPP translation tile may used to convert a corresponding 2D tile into AIPP 3D. This may be done at the client or at the server or in some combination. In one exemplary embodiment, a user my create his own image tiles, request the corresponding AIPP translation tiles then use the AIPP translation tiles to convert his 2D image into AIPP 3D and use the resulting AIPP map as a layer in the Google map interface.

In some embodiments, AIPP tiles and AIPP translation tiles may be stored in a compressed format at a server. The tiles may be decompressed either at the server or at the client. In some embodiments, the display of the AIPP tiles as integrated with Google tiles may be encompassed within an app. In some embodiments, the app may function to determine the exact pixel dimensions and physical size of the screen on which the AIPP map is to be displayed so as to accurately inform the user of the degree of vertical exaggeration in the displayed map (e.g. 12× and 24 inches).

What is claimed is:

1. A method comprising:
receiving a request for tiled map data comprising a request for at least one 3D tile;
retrieving, in response to the request, at least one retrieved 3D tile; and
transmitting the retrieved at least one 3D tile.

2. The method of claim 1 wherein the 3D tile comprises an infinite perspective projection.

3. The method of claim 2 wherein the infinite perspective projection is the Ambroziak Infinite Perspective Projection (AIPP).

4. The method of claim 1 further comprising:
retrieving at least one 2D tile corresponding to the at least one retrieved 3D tile; and
transmitting the retrieved at least one 2D tile.

5. A method comprising:
transmitting a request for tiled map data comprising a request for at least one 3D tile;
receiving the requested at least one 3D tile;
displaying the received at least one 3D tile.

6. The method of claim 5 wherein the 3D tile comprises an infinite perspective projection.

7. The method of claim 6 wherein the infinite perspective projection is the Ambroziak Infinite Perspective Projection (AIPP).

8. The method of claim 5 further comprising:
receiving at least one 2D tile corresponding to the at least one retrieved 3D tile; and
displaying the received at least one 3D tile as an overlay to the received at least one 2D tile.
